(19) United States
(12) Patent Application Publication
(10) Pub. No.: US 2008/0109784 A1
(43) Pub. Date: May 8, 2008

(54) NON-DESTRUCTIVE AUTOMATED XML FILE BUILDERS

(75) Inventors: Brian J. Levine, Chelmsford, MA (US); Philippe Riand, Chelmsford, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Atmonk, NY (US)

(21) Appl. No.: 11/556,789

(22) Filed: Nov. 6, 2006

(51) Int. Cl. G06F 9/44

(52) U.S. Cl. 717/106

(57) ABSTRACT

Embodiments of the present invention address deficiencies of the art in respect to the manual modification of automatically generated source code and provide a method, system and computer program product for the non-destructive generation of markup defining an artifact in an integrated development environment. In one embodiment of the invention, a method for non-destructively building markup language representations of markup data artifacts can include loading markup representing a markup data artifact, such as an extensible markup language (XML) data artifact, and executing logical expressions in the markup to locate automatically generated portions of the markup. The method further can include deleting the located automatically generated portions of the markup, adding new automatically generated portions to the markup, computing new logical expressions for each of the new automatically generated portions, and writing the computed new logical expressions to the markup.

### BACKGROUND OF THE INVENTION

1. Field of the Invention

The present invention relates to the field of automatically generated source code modification in an integrated development environment, and more particular to the modification of a markup defining a markup data artifact.

2. Description of the Related Art

Software development relates to the creation of a software application and the deployment of the application to the end user. Historically, the term “software application” referred to a single computer program incorporating both program logic and supporting resources including user interface elements and data files. Over time, the concept of the software application matured into a carefully orchestrated arrangement of program objects and supporting resources. To manage this careful orchestration, sophisticated integrated development environments were created and distributed into the marketplace. Modern forms of the integrated development environment permit team collaboration and document versioning in addition to the core function of arranging components and resources into a single application.

Until recently, incremental improvements in a software application were reflected in different, discrete versions of the application which were deployed periodically through physical distribution channels such as computer software retail outlets and authorized consultants. More recently, the advancement of computer communications networks have permitted the widespread and repeated deployment of applications through different versions over private networks and the global Internet. The most sophisticated of computing environments now permit the private distribution of applications to internal users through secure, private networks.

Software applications no longer refer to shrink-wrapped products distributable to the public at large. Given the complexity of different instances of the modern business model, very seldom can a single application or even a collection of widely distributed applications satisfy the operational needs of an organizational end user. Consequently, more frequently, organizations have turned to collaborative environments where custom components can be assembled on an ad hoc basis by the organization itself in order to produce in the aggregate a targeted computing solution able to meet the needs of the organization. Once such collaborative environment is the Lotus® Workplace® environment.

Collaborative environments often provide internal development tools which allow the end user to specify the assembly of software artifacts into an application and to custom develop those artifacts. Today, the Eclipse development model as part of the Eclipse™ platform (Eclipse is a trademark of the Eclipse Foundation) supports the assembly of artifacts into an application and the deployment of the application to end users. Oftentimes, end users prefer to modify the data files of a collaborative application. Advanced internal development tools permit the modification of such files through the manual editing of markup defining the data. The data files can represent user interfaces, or any kind of data modelized using a markup based languages.

The process within an integrated development environment of manually editing source code in general has been a challenging process due to the difficulties in coordinating end user manual actions with the automated actions of the integrated development environment. To facilitate the process, source code generated automatically includes embedded comments indicating where and how the end user is to manually modify the source code to achieve the desired customization. The end user, in turn, can apply modifications as specified by the markup. However, in the event that the end user commands the re-generation of the source code, all modifications will be lost in a destructive code re-generation process.

Similar problems exist in the extensible markup language (XML) data artifact modification space. Generally, when modifying markup for an XML data artifact in an internal development tool for a collaborative environment, the markup can be provided with internal comments specifying where and how to modify the markup to achieve a modification to the corresponding artifact. When commanding the regeneration of the markup for the artifact, however, any and all changes manually applied by the end user will be lost in a destructive process.

### BRIEF SUMMARY OF THE INVENTION

Embodiments of the present invention address deficiencies of the art in respect to the manual modification of automatically generated source code and provide a novel and non-obvious method, system and computer program product for the non-destructive generation of markup defining an artifact in an integrated development environment. In one embodiment of the invention, a method for non-destructively building markup language representations of markup data artifacts can be provided. The method can include loading markup representing a markup data artifact and executing logical expressions in the markup to locate automatically generated portions of the markup. The method further can include deleting the located automatically generated portions of the markup, adding new automatically generated portions to the markup, computing new logical expressions for each of the new automatically generated portions, and writing the computed new logical expressions to the markup.

In one aspect of the embodiment, the markup can be an XML document representing an XML data artifact. To that end, loading markup representing an XML data artifact can include loading markup representing an XML data artifact into a document object model (DOM) for the markup. As such, executing logical expressions in the markup to locate automatically generated portions in the markup can include locating a comments node in the DOM, and executing each XML path (XPath) expression in the comments node to locate main nodes in the DOM containing the automatically generated portions.

Deleting the located automatically generated portions from the markup can include deleting each main nodes resolved by executing a corresponding XPath expression. Likewise, adding new automatically generated portions to the markup can include writing new main nodes to the DOM. In the latter circumstance, each of the new main nodes can include new automatically generated portions to the markup, and computing new logical expressions for each of the new automatically generated portions, can include computing new XPath expressions, resolving to the corresponding new main nodes.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a integrated development data processing system configured for the non-destructive generation of markup defining a markup data artifact;

FIG. 2 is a block diagram illustrating a file structure for non-destructive automatically generated markup defining a markup data artifact; and,

FIG. 3 is a flow chart illustrating a process for the non-destructive generation of markup defining a markup data artifact.

### DETAILED DESCRIPTION OF THE INVENTION

Embodiments of the present invention provide a method, system and computer program product for the non-destructive generation of markup defining a markup data artifact such as an XML data artifact. In accordance with an embodiment of the present invention, an artifact can be described by multiple different nodes in a DOM for corresponding markup. The multiple different nodes of the markup can correspond to automatically generated portions of the markup. Additionally, XPath expressions can be computed for the different nodes and written to a comments portion of the markup. Thereafter, manual portions to the markup can be applied to customize the artifact.

When re-generating the markup, the markup can be loaded and mapped into a DOM. The comments portion of the markup can be located and all contained Xpath expressions can be processed to resolve to different nodes in the DOM for the markup. Each resolved one of the different nodes in the DOM can be deleted from the markup and new nodes can be added to the markup in accordance with the automatically annotated portions of the markup describing an updated form of the artifact. Importantly, none of the nodes associated with the manual portions to the markup can be deleted as no XPath expressions in the comment section of the markup section will resolve to nodes in the DOM corresponding to the manual portions.

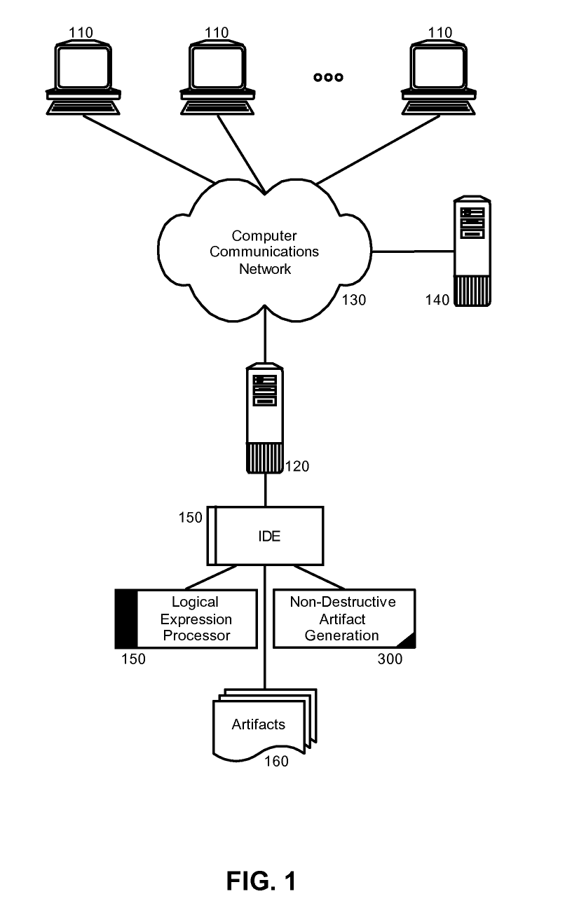

In further illustration, FIG. 1 is a schematic illustration of an integrated development data processing system configured for the non-destructive generation of markup defining a markup data artifact such as an XML data artifact. As shown in FIG. 1, a collaboration server 120 can be provided to support collaborative computing for the environment in conjunction with a portal server 140 configured to deploy a portal interface for the collaborative environment to one or more managed clients 110 over a computer communications network 130. The collaboration server 120 additionally can host an integrated development environment 150 able to provide customized components for the collaboration environment. To that end, the integrated development environment 150 can implement and extend the Eclipse platform

The integrated development environment 150 can provide an interface and logic enabled to produce one or more markup data artifacts 160, for example XML data artifacts, for deployment into the collaborative environment for use by the managed clients 110. To that end, non-destructive artifact generation logic 300 can be coupled to the integrated development environment 150 along with an XPath expression processor 150. The non-destructive artifact generation logic 300 can include program code enabled to non-destructively re-generate markup for the markup data artifacts 160 without destroying any manual portions to the markup representing user modifications to the artifacts 160.

Specifically, the program code of the non-destructive artifact generation logic 300 can be enabled to invoke the XPath Expression Processor 150 to compute XPath expressions for all nodes in a DOM for markup defining an artifact 160. Thereafter, the XPath expressions can be written to the comments portion of the markup. During artifact re-generation, the XPath expressions in the comment portion of the markup can be resolved to nodes in a DOM for the markup in order to identify those portions of the markup that can be deleted. Importantly, manual portions to the markup will not include corresponding XPath expression evaluations and therefore will not be deleted during artifact re-generation.

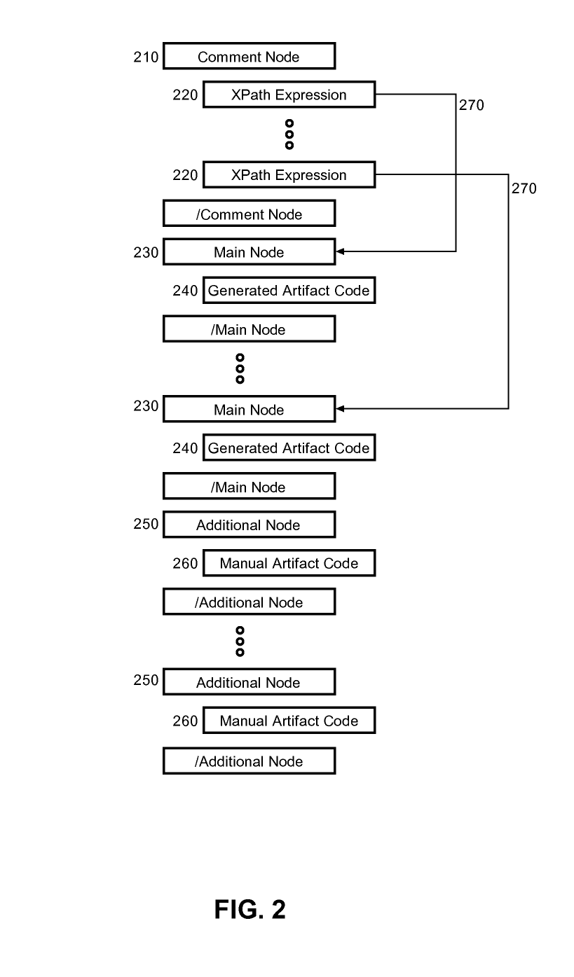

In yet further illustration, FIG. 2 is a block diagram illustrating a file structure for non-destructive automatically generated markup defining a markup data artifact such as an XML data artifact. As shown in FIG. 2, the file structure, typically represented by a DOM for markup, can include a comment node 210, a set of main nodes 230 and additional nodes 250. The main nodes 230 differ from the additional nodes 250 in that the main nodes 230 of the DOM include generated artifact code 240, whereas the additional nodes 250 of the DOM include manual artifact code 260. The comment node 210, in turn, can include a set of XPath expressions 220, each corresponding to a set of different main nodes 230 through a resolved link 270. Accordingly, by processing the XPath expressions 220, the generated artifact code 260 can be readily identified to the exclusion of any manual artifact code 240 for markup defining an artifact.

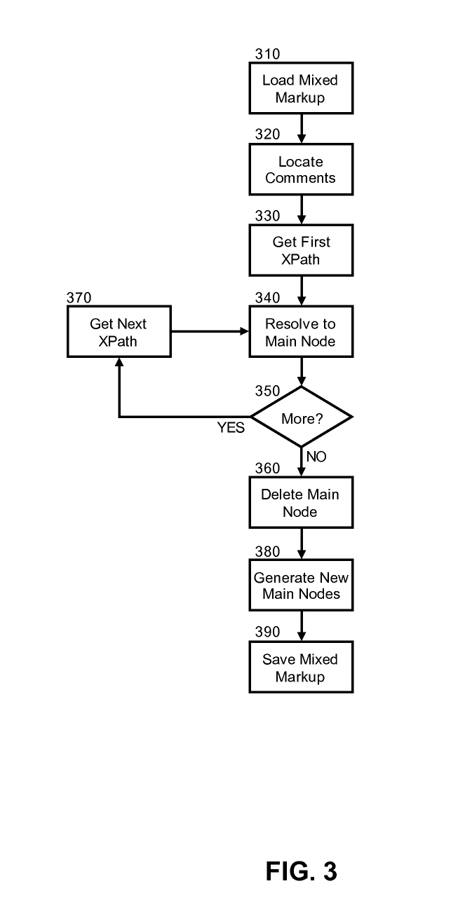

In even yet further illustration, FIG. 3 is a flow chart illustrating a process for the non-destructive generation of markup defining a markup data artifact. Beginning in block 310, a markup language representation of an artifact, for instance an XML representation of an artifact, can be loaded into manipulable form, for instance in a DOM. In block 320, the comments for the markup can be located and in block 330, a first logical expression can be retrieved which when executed resolves to a position within the markup. In block 340, the logical expression can be executed to resolve to nodes within the DOM for an automatically generated portion of the markup. The selected nodes are kept to list.

In decision block 350, it can be determined if additional logical expressions remain to be processed in the comment portion of the markup. If so, in block 370, a next logical expression can be retrieved and the process can repeat through block 340. In decision block 350, when it is determined that no additional logical expressions remain to be processed in the comment portion of the markup, the process can continue through block 360. In block 360, the previously selected nodes can be deleted, thereby removing the automatically generated portion of the markup from the markup. In block 380, any new nodes reflecting newly generated portions of markup can be added to the logical representation of the markup. Finally, in block 390, the markup, including both the automatically generated portions and the user applied manual portions, can be saved.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for non-destructively building markup language representations of markup data artifacts, the method comprising:
loading markup representing a data artifact;
executing logical expressions in the markup to locate automatically generated portions in the markup;
deleting the located automatically generated portions from the markup;
adding new automatically generated portions to the markup;
computing new logical expressions for each of the new automatically generated portions; and,
writing the computed new logical expressions to the markup.

2. The method of claim 1, wherein loading markup representing a data artifact, comprises loading markup representing an extensible markup language (XML) data artifact into a document object model (DOM) for the markup.

3. The method of claim 1, wherein executing logical expressions in the markup to locate automatically generated portions in the markup, comprises:
locating a comments portion of the markup; and,
executing each logical expression in the comments portion to locate automatically generated portions in the markup.

4. The method of claim 2, wherein executing logical expressions in the markup to locate automatically generated portions in the markup, comprises:
locating a comments node in the DOM; and,
executing each XML path (XPath) expression in the comments node to locate main nodes in the DOM containing the automatically generated portions.

5. The method of claim 4, wherein deleting the located automatically generated portions from the markup, comprises deleting each main node resolved by executing a corresponding XPath expression.

6. The method of claim 5, wherein adding new automatically generated portions to the markup, comprises writing new main nodes to the DOM, each of the new main nodes including new automatically generated portions to the markup.

7. The method of claim 6, wherein computing new logical expressions for the new automatically generated portions, comprises computing new XPath expressions, each resolving to a corresponding set of the new main nodes.

8. An integrated development data processing system for non-destructively building artifact representations in markup, the system comprising:
an integrated development environment;
a logical expression processor; and,
non-destructive artifact generation logic, the logic comprising program code enabled to invoke the logical expression processor to execute logical expressions in the markup to locate automatically generated portions in the markup, the logic further comprising program code to delete the located automatically generated portions from the markup and to add new automatically generated portions to the markup, the logic yet further comprising program code to invoke the logical expression processor to compute new logical expressions for each of the new automatically generated portions, the logic even yet further comprising program code to write the computed new logical expressions to the markup.

9. The system of claim 8, wherein the logical expression processor comprises an extensible markup language (XML) path (XPath) expression processor.

10. The system of claim 9, wherein the logical expressions are XPath expressions each resolving to a set of nodes in a document object model (DOM) for the markup, the set of nodes in each instance including automatically generated portions for the markup.

11. A computer program product comprising a computer usable medium having computer usable program code for non-destructively building markup language representations of markup data artifacts, the computer program product including:
computer usable program code for loading markup representing a markup data artifact;
computer usable program code for executing logical expressions in the markup to locate automatically generated portions in the markup;
computer usable program code for deleting the located automatically generated portions from the markup;
computer usable program code for adding new automatically generated portions to the markup;
computer usable program code for computing new logical expressions for each of the new automatically generated portions; and,
computer usable program code for writing the computed new logical expressions to the markup.

12. The computer program product of claim 11, wherein the computer usable program code for loading markup representing a markup data artifact, comprises computer usable program code for loading markup representing an extensible markup language (XML) data artifact into a document object model (DOM) for the markup.

13. The computer program product of claim 11, wherein the computer usable program code for executing logical expressions in the markup to locate automatically generated portions in the markup, comprises:
computer usable program code for locating a comments portion of the markup; and,
computer usable program code for executing each logical expression in the comments portion to locate automatically generated portions in the markup.

14. The computer program product of claim 12, wherein the computer usable program code for executing logical expressions in the markup to locate automatically generated portions in the markup, comprises:
computer usable program code for locating a comments node in the DOM; and,
computer usable program code for executing each XML path (XPath) expression in the comments node to locate main nodes in the DOM containing the automatically generated portions.

15. The computer program product of claim 14, wherein the computer usable program code for deleting the located automatically generated portions from the markup, comprises computer usable program code for deleting each main node resolved by executing a corresponding XPath expression.

16. The computer program product of claim 15, wherein the computer usable program code for adding new automatically generated portions to the markup, comprises computer usable program code for writing new main nodes to the DOM, each of the new main nodes including new automatically generated portions to the markup.

17. The computer program product of claim 16, wherein the computer usable program code for computing new logical expressions for each of the new automatically generated portions, comprises computer usable program code for computing new XPath expressions, each resolving to a corresponding set of the new main nodes.
